(19) United States
(12) Patent Application Publication
(10) Pub. No.: US 2007/0253440 A1
(43) Pub. Date: Nov. 1, 2007

(54) INTERNET COMMUNICATION SYSTEM AND METHOD

(76) Inventor: Li-Ting Huang, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(21) Appl. No.: 11/309,358

(22) Filed: Jul. 31, 2006

(30) Foreign Application Priority Data
Apr. 28, 2006 (TW) 95115229

(51) Int. Cl. H04L 12/66

(52) U.S. Cl. 370/463

(57) ABSTRACT

An internet communication system includes a subscriber line interface circuit (SLIC), a switch unit, an audio Codec unit, and a control unit. The SLIC comprises a first interface for receiving an analog signal and transforming the analog signal into a digital signal. The switch unit connecting with the first interface is used for transforming the digital signal in order to meet an interface format. The audio Codec unit connecting with the switch unit is used for receiving and encoding the digital signal to meet an audio Codec unit format. The control unit connecting with the audio Codec unit is used for receiving and decoding the digital signal according to the audio Codec unit format, providing an internet protocol (IP) address and sending the digital signal to a terminal on the internet protocol (IP) address in order to communicate.

### CROSS-REFERENCE TO RELATED APPLICATION

This application claims the priority benefit of Taiwan application serial no. 95115229, filed on Apr. 28, 2006. All disclosure of the Taiwan application is incorporated herein by reference.

### BACKGROUND OF THE INVENTION

1. Field of Invention

The present invention relates to an internet communication system and method, and particularly to an internet communication system and method by an audio Codec unit and a subscriber line interface circuit (SLIC).

2. Description of Related Art

Due to the development of the communication technology and the popularity of the broad bandwidth network, communication on the internet becomes a trend. It is convenient for people to have audio communication on the internet by an internet telephone. However, in the currently available internet phone software program on computers, a user has to log in his/her own account and key in another user account of a phone answerer in the software program. Then, the user may have a phone call to the phone answerer via the software program. This process is complicated and not convenient for users not good at computer skills.

A prior art, Taiwan Patent No. 438009, discloses an internet phone adaptor and an internet communication system by hardware implementation. FIG. 1 shows a block diagram of the prior art. Please refer to FIG. 1, the internet communication system includes a personal computer 100, a phone set 101 and the internet 102. The personal computer 100 includes an audio adaptor 110 and an internet phone adaptor 130. An internet phone software program 120 is installed in the personal computer 100. The audio adaptor 110 has a microphone jack 111 and a speaker jack 112.

The internet phone adaptor 130 connects to the personal computer 100 via a PCI (Peripheral Component Interconnect) interface. The internet phone adaptor 130 includes an internet control circuit 131, a subscriber line interface circuit (SLIC) 133, a Codec 132, a microphone jack 134 and a speaker jack 135.

Operations of the prior art system are as follows. After a user dials a phone number on the phone set 101, the Codec 132 detects and decodes a phone number signal from the SLIC 132. Then, the Codec 132 drives the internet phone software program 120 and sends out the decoded phone number signal to the internet 102 via the internet control circuit 131.

After the phone call is connected, the internet control circuit 131 stores an audio signal from the phone set 101 into the audio adaptor 110 via a microphone line 103. Then, the internet phone software program 120 compresses the audio signal from the audio adaptor 110 and performs a signal transformation program on the received audio signal. The compressed and transformed audio signal is further processed by the internet control circuit 131 of the internet phone adaptor 130, and then sent out via the internet 102 to an answer's computer with the same or similar internet phone adaptor. Answers from the call answerer are input into the computer 100 via the internet 102. Then, the internet control circuit 131 judges whether the answers are internet phone signals. If yes, the internet phone signals are processed by the internet phone software program 120. The processed phone signals are input into the audio adaptor 110 and then output to the internet phone adaptor 130 via a speaker line 104. The phone signals are output from the SLIC 132, so that the user may hear voices from the call answerer via the receiver of the phone set 101.

In the prior art, the internet phone adaptor 130 is designed for a desk-top computer. So, the internet phone adaptor 130 is difficult to be installed into a note-book computer because of its big size. Further, the data process rate is limited because the internet phone adaptor transmits data via the PCI bus to a CPU, a north bridge chip and a south bridge chip of the computer and the data rate on the PCI bus is slow. Further, the process of the audio signals are complicated and delayed because the audio signals are input into the audio adaptor via the microphone line and the speaker line and then fed back to the internet phone adaptor for outputting.

### SUMMARY OF THE INVENTION

One of the aspects of the invention is to provide an internet communication system for receiving analog signals from a phone set and converting into internet packets for audio communication on the internet to reduce the communication bill.

Another aspect of the invention is to provide an internet communication method, wherein analog signals from a phone set are received by a SLIC and the user may have a communication on the internet conveniently just as he/she use the conventional home phone set.

In order to achieve at least one of the aspects of the invention, the invention provides an internet communication system, including: a subscriber line interface circuit (SLIC), comprising a first interface for receiving an analog signal and transforming the analog signal into a digital signal for outputting; a switch unit, connecting with the first interface, used for receiving and transforming the digital signal in order to meet an interface format; an audio Codec unit, connecting with the switch unit, used for receiving and encoding the digital signal to meet an audio encoding format; and a control unit, connecting with the audio Codec unit, used for receiving and decoding the digital signal according to the audio encoding format to provide an internet protocol (IP) address and connect to a terminal on the internet protocol address in order to communicate.

In the internet communication system, the SLIC receives the analog signal from a phone data port (RJ11) of a phone set.

In the internet communication system, the first interface is a serial peripheral interface (SPI).

In the internet communication system, the audio Codec unit includes a second interface for receiving the digital signal conforming to the interface format and the interface includes a GPIO (general purpose input output) interface format.

In the internet communication system, the audio encoding format includes an AC'97 format or an Azalia audio interface.

In the internet communication system, the control unit includes a south-bridge chip and a processor.

The internet communication system further comprises a signal line, connecting to the audio Codec unit and the SLIC, for sending an audio signal to the audio Codec unit.

In the internet communication system, the control unit further includes an internet audio unit, converting the audio signal into an internet packet for sending to the terminal for communication.

In the internet communication system, the analog signal includes a dial signal.

Further, in order to achieve at least one of the aspects of the invention, the invention provides an internet communication method, including steps of: (a) receiving an analog signal and transforming the analog signal into a digital signal for outputting by a subscriber line interface circuit (SLIC); (b) transforming the digital signal in order to meet an interface format by a switch unit; (c) receiving and encoding the digital signal to meet an audio encoding format by an audio Codec unit; and (d) receiving and decoding the digital signal according to the audio encoding format to provide an internet protocol (IP) address and connect to a terminal on the internet protocol address in order to communicate, by a control unit.

In the internet communication method, the step (a) includes a step of sending the analog signal to the SLIC from a phone data port (RJ11) of a phone set.

In the internet communication method, the step (a) further includes a step of converting the analog signal into the digital signal via a serial peripheral interface (SPI) by the SLIC.

In the internet communication method, in the step (b), the interface format includes a GPIO (general purpose input output) interface format.

In the internet communication method, in the step (c), the audio encoding format includes an AC'97 format or an Azalia audio interface.

The internet communication method further comprises a step of sending an audio signal to the SLIC from the phone data port (RJ11) of the phone set.

The internet communication method further comprises a step of sending the audio signal from the SLIC to the audio Codec unit.

The internet communication method further comprises a step of encoding and outputting the audio signal by the audio Codec unit to the control unit, according to an audio encoding format.

The internet communication method further comprises a step of making an internet audio unit for converting the audio signal into internet packets for sending to the terminal for communication, by the control unit.

The SLIC is added into the motherboard of the personal computer and the analog signals from the phone set are converted into internet packets on the internet for internet communication. The phone bill is lowered and the user may have a communication on the internet conveniently as he/she uses the conventional phone set.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 shows a block diagram of a prior art internet communication system.

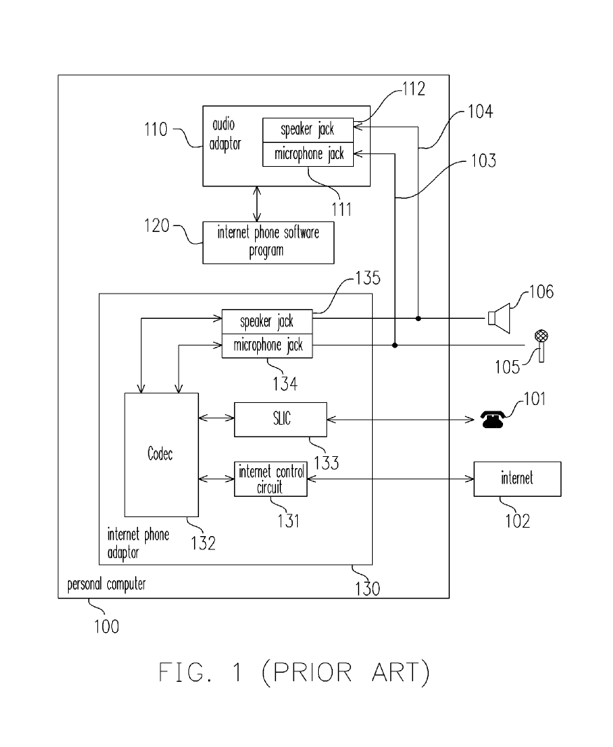

FIG. 2 shows a block diagram of an internet communication system according to a first embodiment of the invention.

FIG. 3 shows a flow chart of an internet communication method according to the first embodiment of the invention.

FIG. 4 shows a block diagram of an internet communication system according to a second embodiment of the invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

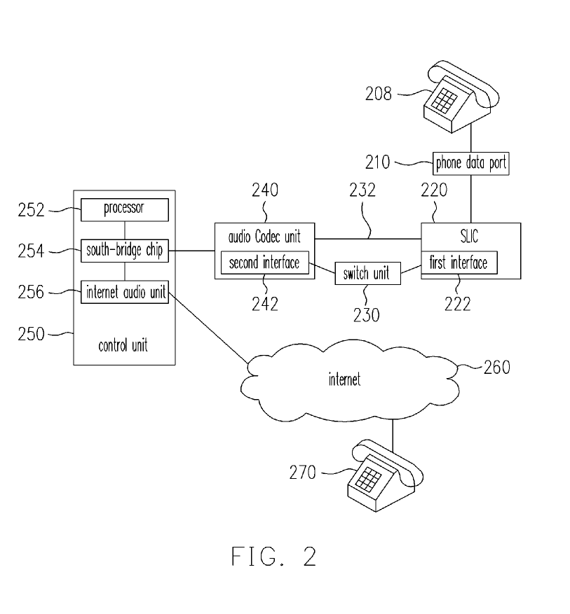

FIG. 2 shows a block diagram of an internet communication system according to a first embodiment of the invention. Please refer to FIG. 2, the internet communication system according to the first embodiment of the invention includes a first phone set 208, a phone data port (RJ11) 210, a subscriber line interface circuit (SLIC) 220, a signal line 232, a switch unit 230, an audio Codec unit 240, a control unit 250, an internet 260 and a second phone set 270. In the first embodiment, the first phone set 208 connects to the SLIC 220 via the phone data port (RJ11) 210 and outputs an analog signal or an audio signal to the SLIC 220. The analog signal is a control signal of the first phone set 208, for example, a dial signal asserted when the user dials. The audio signal comes from the user when the user speaks.

In the first embodiment, the SLIC 220 has a first interface 222, which is for example a SPI (Serial Peripheral Interface) as a signal output interface for receiving and converting the analog signal into a digital signal compatible to the SPI. The SLIC 220 connects to the audio Codec unit 240 via the signal line 232 for sending the audio signal to the audio Codec unit 240. Besides, for preserving the habits of using the phone set by the user, the SLIC 220 has a function of controlling ring tone. In addition to caller ring tone control, after the user dials the phone number, the SLIC 220 controls the receiver of the phone set for making tones waiting for connection or in busy line.

The switch unit 230 connects to the first interface 222, for receiving and converting the digital signal for compatible with an interface format, the interface format being a format decodable by the audio Codec unit 240, for example a GPIO (General Purpose Input Output) format. The audio Codec unit 240 has a second interface 242. The second interface 242 connects to the switch unit 230 for receiving the digital signal compatible with the interface format. The audio Codec unit 240 encodes the digital signal for conforming to an audio encoding format. The audio encoding format is for example, an AC'97 format or an Azalia audio interface.

The control unit 250 connects to the audio Codec unit 240. The control unit 250 includes a processor 252, a south-bridge chip 254 and an internet audio unit 256. The south-bridge chip 254 receives the digital signal. The processor 252 is implemented by a CPU. The south-bridge chip 254, under control of the processor 252, decodes and interprets the digital signal according to audio encoding format. For example, when the user dials the phone number, the digital signals is decoded and interpreted as the phone number dialed by the user.

In the first embodiment, the internet audio unit 256 interprets an internet protocol address (IP) contained in the digital signal for connecting to a terminal on the IP address. The terminal may be another phone set or the second phone set 270, or a personal computer. The internet audio unit 256 further converts the audio signal into internet packets for sending to the second phone set 270 via the internet 260 for communication. The internet audio unit 256 may be implemented by a VoIP (voice over internet protocol) program.

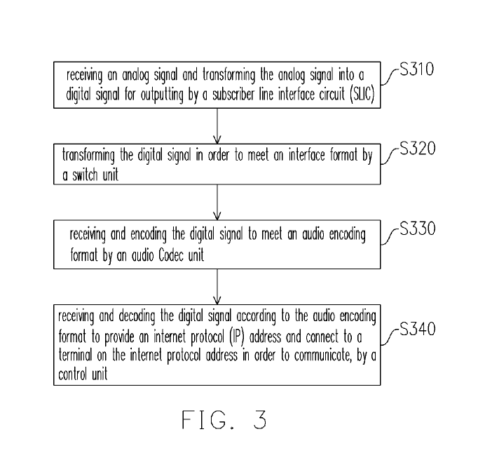

FIG. 3 shows a flow chart of an internet communication method according to the first embodiment of the invention. Please refer to FIGS. 2 and 3 for describing when the user dials on the first phone set 208 for communicating with the answerer on the second phone set 270.

The user dials the phone number on the first phone set 208. The SLIC 220 judges whether the signals from the first phone set 208 includes dial signals when the user dials or the audio signals when the user speaks. When the signals from the first phone set 208 includes dial signals, the first phone set 208 sends the analog signal to the SLIC 220 via the phone data port (RJ11) 210. The SLIC 220 receives the analog signal and based on SPI format, converts into the digital signal for outputting, as shown in Step S310.

The switch unit 230 receives the digital signal and converts the digital signal for conforming to the interface format, for example, the GPIO format, as shown in Step S320.

The audio Codec unit 240 receives the digital signal and interprets the digital signal according to an audio encoding format which is for example an AC'97 format or an Azalia audio interface, as shown in Step S330.

The control unit 250 receives the digital signal from the audio Codec unit 240 and interprets an IP address from the digital signal according to the audio encoding format for connecting to the second phone set 270 on the IP address and thus, the second phone set 270 issues a caller signal, as shown in Step S340.

In the Step S310, when the signal from the first phone set 208 is the audio signal, in other words, the connection between the first phone set 208 and the second phone set 270 is connected, the first phone set 208 sends the audio signal to the SLIC 220. The SLIC 220 sends the audio signal to the audio Codec unit 240. The audio Codec unit 240 encodes the audio signal according to the audio encoding format and outputs to the control unit 250. The control unit 250 converts the audio signal into internet packets via the internet audio unit 256 for sending to the second phone set 270 for communication.

Compared to the prior art, in the first embodiment, the audio Codec unit 240 decodes/encodes the audio/analog signals and the control signals, for example the dial signals, from the SLIC 220. Besides, because the south-bridge chip 254 communicates with the audio Codec unit 240, the processor 252 controls the audio Codec unit 240 and the SLIC 220 via the south-bridge chip 254. Other control chips, which can communicate with the audio Codec unit 240, may be used for implementing the south-bridge chip 254.

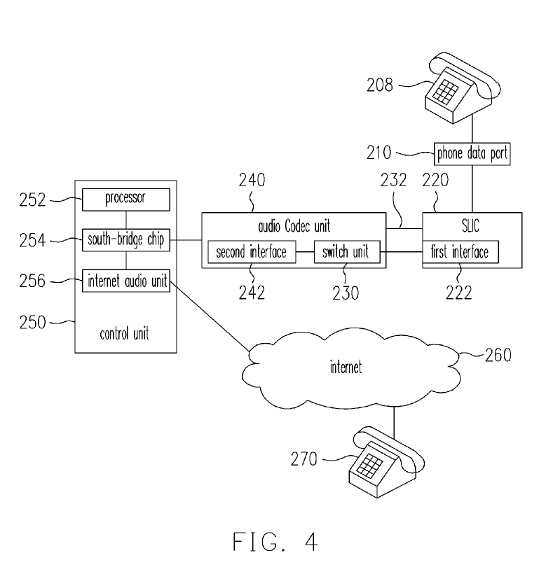

Now please refer to FIG. 4 which shows a block diagram of an internet communication system according to a second embodiment of the invention. In FIG. 4, the switch unit 230 is disposed inside the audio Codec unit 240, rather than outside the audio Codec unit 240 in the first embodiment.

From the above description, it is known that, compared with the prior art, in the embodiments, the SLIC 220 is added into the motherboard of the personal computer, which means the personal computer has the function of internet communication. Via the signal communication between the SLIC and the audio Codec, the audio signal process is simplified and in high speed.

In the internet communication systems according to the above embodiments of the invention, the SLIC is added to the motherboard and the internet communication is achieved by the signal interchange between the SLIC and the audio Codec. Because the way to use the phone set in the above embodiments is similar to the conventional way to use the home phone set, the user may have a communication on the internet conveniently just as he/she uses the conventional home phone set.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. An internet communication system, including:
a subscriber line interface circuit (SLIC), comprising a first interface for receiving an analog signal and transforming the analog signal into a digital signal for outputting;
a switch unit, connecting with the first interface, used for receiving and transforming the digital signal in order to meet an interface format;
an audio Codec unit, connecting with the switch unit, used for receiving and encoding the digital signal to meet an audio encoding format; and
a control unit, connecting with the audio Codec unit, used for receiving and decoding the digital signal according to the audio encoding format to provide an internet protocol (IP) address and connect to a terminal on the internet protocol address in order to communicate.

2. The internet communication system of claim 1, wherein the SLIC receives the analog signal from a phone data port (RJ11) of a phone set.

3. The internet communication system of claim 1, wherein the first interface is a serial peripheral interface (SPI).

4. The internet communication system of claim 1, wherein the audio Codec unit includes a second interface for receiving the digital signal conforming to the interface format and the interface includes a GPIO (general purpose input output) interface format.

5. The internet communication system of claim 1, wherein the audio encoding format includes an AC'97 format or an Azalia audio interface.

6. The internet communication system of claim 1, wherein the control unit includes a south-bridge chip and a processor.

7. The internet communication system of claim 1, further comprising a signal line, connecting to the audio Codec unit and the SLIC, for sending an audio signal to the audio Codec unit.

8. The internet communication system of claim 7, wherein the control unit further includes an internet audio unit, converting the audio signal into an internet packet for sending to the terminal for communication.

9. The internet communication system of claim 1, wherein the analog signal includes a dial signal.

10. An internet communication method, including steps of:
(a) receiving an analog signal and transforming the analog signal into a digital signal for outputting by a subscriber line interface circuit (SLIC);
(b) transforming the digital signal in order to meet an interface format by a switch unit;
(c) receiving and encoding the digital signal to meet an audio encoding format by an audio Codec unit; and
(d) receiving and decoding the digital signal according to the audio encoding format to provide an internet protocol (IP) address and connect to a terminal on the internet protocol address in order to communicate, by a control unit.

11. The internet communication method of claim 10, wherein the step (a) includes a step of sending the analog signal to the SLIC from a phone data port (RJ11) of a phone set.

12. The internet communication method of claim 10, wherein the step (a) further includes a step of converting the analog signal into the digital signal via a serial peripheral interface (SPI) by the SLIC.

13. The internet communication method of claim 10, wherein in the step (b), the interface format includes a GPIO (general purpose input output) interface format.

14. The internet communication method of claim 10, wherein in the step (c), the audio encoding format includes an AC'97 format or an Azalia audio interface.

15. The internet communication method of claim 11, further comprising a step of sending an audio signal to the SLIC from the phone data port (RJ11) of the phone set.

16. The internet communication method of claim 15, further comprising a step of sending the audio signal from the SLIC to the audio Codec unit.

17. The internet communication method of claim 16, further comprising a step of encoding and outputting the audio signal by the audio Codec unit to the control unit, according to an audio encoding format.

18. The internet communication method of claim 17, further comprising a step of making an internet audio unit for converting the audio signal into internet packets for sending to the terminal for communication, by the control unit.
